(19) United States
(12) Patent Application Publication
(10) Pub. No.: US 2023/0303440 A1
(43) Pub. Date: Sep. 28, 2023

(54) HEMP-BASED BIO-COMPOSITE MASONRY UNITS, COMPOSITIONS, METHODS OF MAKING AND USING

(71) Applicant: Earth Merchant INC, Vancouver, WA (US)

(72) Inventor: Gina Engel, Vancouver, WA (US)

(21) Appl. No.: 18/131,331

(22) Filed: Apr. 5, 2023

Related U.S. Application Data
(60) Provisional application No. 63/328,160, filed on Apr. 6, 2022.

(51) Int. Cl. C04B 18/24; C04B 28/12; C04B 40/00

(52) U.S. Cl. CPC C04B 18/248; C04B 28/12; C04B 40/0032; C04B 40/0042

(57) ABSTRACT

A masonry unit composed of hydraulic lime binder and hemp hurd in a hydraulic lime binder:hemp hurd ratio of 1.4:1 to 1.6:1, wherein the hydraulic lime binder includes less than 1% by weight of each of potassium oxide (K₂O), sodium oxide (Na₂O), and sulfur trioxide (SO₃), and wherein the masonry unit has a front surface, a rear surface, a first side surface and an opposing second side surface. The front surface has a larger surface area than the rear surface, and the first side surface and second side surface each include a shoulder. A biocomposite material, settable formulations, and method of preparing a masonry unit are also described.

### CROSS REFERENCE TO RELATED APPLICATIONS

This application claims benefit under 35 U.S.C. 119(e) to U.S. Provisional Pat. Application Serial No. 63/328,160, entitled, “Hemp-Based Bio-Composite Masonry Units, Compositions, Methods of Making and Using,” and filed 06 Apr. 2022, the contents of which are incorporated herein in their entirety for all purposes.

### FIELD

The present disclosure relates to masonry units composed of botanical ingredients. More specifically, the present disclosure relates to hemp-based masonry units, biocomposite material, settable formulations, and methods of making and using hemp-based masonry units.

### BACKGROUND

Masonry involves the building of structures from individual units, which are often laid in and bound together by a binding material (such as mortar). The term masonry can also refer to the units themselves. Common materials of masonry construction include concrete block, brick, building stone such as marble, granite, and limestone, cast stone, glass block, and adobe. Technically speaking, the term “brick” denotes a block composed of dried clay, but it is now also used informally to denote other chemically cured construction blocks. “Block” is a similar term referring to a rectangular building unit composed of similar materials; however, blocks are usually larger than bricks. Masonry is generally a highly durable form of construction.

Cement is a finite resource that generates significant pollution during production. Cement can be mixed with fine aggregate to produce mortar for masonry, or it can be mixed with sand and gravel to produce concrete. Concrete production has been estimated to contribute more than 8% of global greenhouse gases emissions, while the construction industry worldwide has been estimated to contribute about 18%. For example, traditional bricks, which are heated at temperatures of more than 1,000° C., produce significant carbon dioxide emissions.

Hemp hurd (also called shives) has been recognized as a valuable green building material in hempcrete, mulch, ceilings, tiles, and the like. Hemp hurd is a naturally biodegradable product that has valuable applications in sustainable housing and biodegradable building structures. The building and construction industries have embraced the environmental benefits of this strong and versatile product. Industrial hemp can be grown without pesticides or chemical fertilizers, requires less water than crops like cotton or corn, and reaches maturity one hundred days from planting. As used herein, “industrial hemp” is a botanical class of Cannabis sativa cultivars grown specifically for industrial or medicinal use. Hemp photosynthesizes carbon dioxide with greater efficiency than trees and can be harvested twice per year, doubling the rate of carbon sequestration.

Hemp hurd can be mixed with a lime-based binder, then packed into molds to produce hemp hurd concrete (also known as hempcrete). The lime petrifies the organic hemp hurd once it sets. When the hempcrete is set, it is strong but also flexible. Hempcrete can have several beneficial properties such as lighter weight (as compared to concrete), improved durability when exposed to earthquakes, natural insulation properties, termite resistance, fire resistance, and natural antimicrobial properties. Hempcrete structures can last for hundreds of years but are also ultimately biodegradable. Further, hempcrete absorbs more carbon from the atmosphere than it gives off in production, making it a carbon-negative product.

Hempcrete requires an extended drying time to cure, and this has proved a barrier to the adoption of hempcrete as a standard building material within the construction industry. Much hemp construction involves on-site mixing of hempcrete and lime, pouring the material between framing studs, and applying reusable formwork to hold the walls plumb as they dry. The drying process is crucial for hempcrete which is highly porous and dense; therefore, the moisture levels require time to equalize with the ambient environment. As a result, hempcrete walls can take between two and eight weeks to dry depending on humidity, airflow, and other factors. Lengthy drying times are not practical for much of commercial construction.

### SUMMARY

The present disclosure is directed to hemp-based biocomposite masonry units that are useful in construction. In some aspects, the masonry units can be provided in the form of bricks, blocks, slabs, tiles, boards, panels, shingles, siding, columns, and the like. Hemp-based biocomposite compositions can be used as masonry in that individual units of the composition can be assembled to provide a structure. Masonry units in accordance with some implementations can be load-bearing or non-load bearing, structural or decorative. In some aspects, the masonry units can be used as an interior component, such as infill between an exterior wall and interior wall of a building. In some aspects, the masonry units can be used as an exterior component or veneer, such that the units are visible during use as shingles, siding, columns, panels, or other visible components of the exterior or interior of a building. When used as a veneer, units can be installed on one or both sides of a structurally independent wall constructed of the same or different material.

In accordance with some implementations, a masonry unit can comprise hydraulic lime binder and hemp hurd in a hydraulic lime binder:hemp hurd weight ratio of about 1.4:1 to about 1.6:1, wherein the hydraulic lime binder comprises less than 1% by weight of each of potassium oxide (K₂O), sodium oxide (Na₂O), and sulfur trioxide (SO₃), based on total weight of the hydraulic lime binder, and wherein the masonry unit comprises a front surface, a rear surface, a first side surface and an opposing second side surface, wherein the front surface comprises a larger surface area than the rear surface, and the first side surface and second side surface each include a shoulder. In these aspects, the hydraulic lime binder comprises less than 1% by weight of potassium oxide, less than 1% by weight of sodium oxide, and less than 1% by weight of sulfur trioxide, based on total weight of the hydraulic lime binder. In various aspects, a masonry unit comprises more hydraulic lime binder by weight than hemp hurd.

In various implementations, masonry units can comprise durable, lightweight, carbon-negative construction blocks, bricks and other forms.

Optional components include one or more nanosized materials such as pozzolans, nanocellulose, and graphene. Suitable pozzolanic materials can include natural and artificial materials such as hemp-based biochar, pozzolanic ash, silica fume, fly ash, rice husk ash, and the like. In some embodiments, a coating can be provided on one or more surfaces of the masonry unit.

In some implementations, masonry units described herein can help meet the need for improved energy efficiency in homes by offering one or more benefits such as robust insulation properties, low thermal conductivity, and innovative hygrothermal performance. In some aspects, masonry units can exhibit R 0.9 per inch or greater, or 1.0 per inch or greater, or R 1.5 per inch or greater, or R 1.8 per inch or greater, or R 2.0 per inch or greater, or R 2.1 per inch or greater, or R 2.2 per inch or greater, or R 2.3 per inch or greater, or R 2.4 per inch or greater, a net improvement over traditional façade wall systems with the current standard of masonry brick at R 0.2 to R 0.7 per inch. In some implementations, masonry units can exhibit R 2.4 per inch.

In some implementations, masonry units can provide innovative thermal performance benefits beyond steady-state R-values, making them uniquely suited for improving not just energy efficiency, but also indoor air quality. In some aspects, masonry units can be vapor active, having pore structure and pore connectivity that responds to changes in humidity by absorbing and releasing moisture. This can create a hygric buffer, and since moisture transport through a building envelope significantly impacts air-conditioning loads, such buffering can, in some implementations, reduce energy consumption by about 45% compared to cellular concrete.

In some aspects, additional beneficial properties can include one or more of the following: improved compressive strength, tensile and lateral strength, fire resistance, and resistance to projectiles (such as debris from storms such as hurricanes or tornadoes). In some aspects, masonry units can reduce water absorption and structural swelling with low thermal expansion and lower density than comparable reinforcing materials.

In some aspects, reduced-carbon footprint hemp-based biocomposite materials, settable formulations comprising these biocomposite materials, and masonry units composed of these biocomposite materials are provided. A substantial reduction in carbon footprint may result from using reduced-carbon footprint hemp-based biocomposite materials. For example, a substantial carbon reduction may result from combining: (a) a cement credit (i.e., the CO₂ avoided) from offsetting the use of ordinary Portland cement, with (b) the quantity of sequestered carbon that results from use of biocomposite materials described herein.

In some implementations, masonry units can be used as non-structural infill for wall systems and as façade pieces in residential and commercial construction. Optionally, exterior coating materials such as a lime-based plaster can be applied to finish the walls and weatherize them. In various implementations, the technology can be used in new construction, remodel projects, and outdoor projects such as garden walls.

In some implementations, biocomposite materials can comprise hydraulic lime binder and hemp hurd in a hydraulic lime binder:hemp hurd weight ratio of 1.4:1 to 1.6:1, wherein the hydraulic lime binder comprises less than 1% by weight of each of potassium oxide (K₂O), sodium oxide (Na₂O), and sulfur trioxide (SO₃), based on total weight of the hydraulic lime binder. In these aspects, the hydraulic lime binder comprises less than 1% by weight of potassium oxide, less than 1% by weight of sodium oxide, and less than 1% by weight of sulfur trioxide, based on total weight of the hydraulic lime binder.

Optionally, the biocomposite material can further include one or more nanosized materials such as pozzolans, nanocellulose, and graphene. Suitable pozzolanic materials can include natural and artificial materials such as hemp-based biochar, pozzolanic ash, silica fume, fly ash, rice husk ash, and the like.

In further aspects, the biocomposite material can be combined with a liquid (e.g., water) to prepare a settable formulation. When the liquid comprises water, a settable formulation can comprise biocomposite material and water in a biocomposite material:water weight ratio of 0.9:1 to 1:1.

In some implementations, methods of preparing a masonry unit can comprise steps of:
combining hydraulic lime binder and hemp hurd in a hydraulic lime binder:hemp hurd weight ratio of 1.4:1 to 1.6:1 to form a biocomposite material, wherein the hydraulic lime binder comprises less than 1% by weight of each of potassium oxide (K₂O), sodium oxide (Na₂O), and sulfur trioxide (SO₃), based on total weight of the hydraulic lime binder;
adding water to the biocomposite material with mixing to form a settable formulation, wherein the biocomposite material and water are present in a weight ratio of 0.9:1 to 1:1;
providing the settable formulation into molds for a suitable time to allow initial set of the formulation;
removing the molds to expose masonry units; and
allowing the masonry units to cure.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The disclosure may be more completely understood in consideration of the accompanying drawings, in which:

FIGS. 1A - 1D illustrate photographs of hemp hurd in accordance with various implementations described herein;

FIG. 2A illustrates sample weight over time as blocks prepared in accordance with various implementations were dried;

FIG. 2B illustrates sample weight over time for blocks prepared in accordance with various implementations and then dried using an accelerated drying method;

FIG. 3 illustrates a comparison of flexural strength of blocks prepared under different conditions of drying in accordance with various implementations;

FIG. 4 illustrates flexural testing of hurd types and drying methods in accordance with various implementations;

FIG. 5 illustrates results and comparison of flexural strength property means, for hurd type and drying methods (FIG. 5A), and results and comparison of thermal resistance means, for various hurd and coat treatment (FIG. 5B) in accordance with various implementations;

FIG. 6 illustrates results from flexural strength 3-Point Bend Tests of masonry blocks prepared in accordance with various implementations;

FIG. 7 illustrates hurd particle size distribution for two types of hemp hurd used in accordance with various implementations;

FIG. 8 illustrates one embodiment of a masonry unit in accordance with various implementations;

FIGS. 9A, 9B, and 9C illustrate masonry units installed in framing for building construction in accordance with various implementations.

The figures are not necessarily to scale. Like numbers in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

In this description, the directional prepositions of up, upwardly, down, downwardly, front, back, top, upper, bottom, lower, left, right, side, and other such terms refer to a masonry unit as it is oriented and appears in the drawings and are used for convenience only; they are not intended to be limiting or to imply that the masonry unit has to be used or positioned in any particular orientation.

Generally, when referring to masonry units herein, reference will be made to blocks and bricks. Blocks and bricks will be utilized to describe various embodiments, as these applications are useful to highlight features and advantages. However, it will be understood upon review of the present specification that masonry units, biocomposite material, and settable formulations can be adapted to different configurations and additional uses, such as decorative units, columns, finishing pieces, and the like.

In some aspects, masonry units can comprise hydraulic lime binder and hemp hurd in a hydraulic lime binder:hemp hurd weight ratio of 1.4:1 to 1.6:1, wherein the hydraulic lime binder comprises less than about 1% by weight of each of potassium oxide (K₂O), sodium oxide (Na₂O), and sulfur trioxide (SO₃), based on total weight of the hydraulic lime binder, and wherein the masonry unit comprises a front surface, a rear surface, a first side surface, and an opposing second side surface, wherein the front surface comprises a larger surface area than the rear surface, and the first side surface and second side surface each include a shoulder.

Suitable hemp hurd can be obtained from industrial hemp. Industrial hemp is a variety of the Cannabis sativa plant that is one of close to 200 species in the Cannabaceae family. The plant is constituted of stalks, flowers, bast fibers, leaves, and hurd (which is the woody core of the plant). Once industrial hemp is harvested, stalks are allowed to rett. Retting is the process in which the pectins in the hemp plant naturally rot away so that the stalks lose adhesion, allowing the hurd to separate from the outer part of the stalk. Retting can take from two to six weeks, at which point the hurd and fiber are baled. Next, the hurd is separated from the fiber through the process of decortication, which can be achieved manually, or with the use of industrial decorticating machines.

The separated hurd is useful in accordance with various implementations. Suitable hemp hurd can have one or more of the following properties:

| | |
|---|---|
| Specific heat (c) | 1950J / (kg.K) |
| Density (kg / m³) | 100 - 300 |
| Thermal conductivity w / m°C | 0.048 - 0.069 |
| Coefficient of resistance to water vapor diffusion (µ) | 1 to 2 |
| Fire class | E |

In some implementations, specific heat can be measured by exposing a sample of the material (such as a formed block) to a propane blowtorch for thirty (30) seconds.

In accordance with various implementations, separated hemp hurd can be ground in a cutting mill equipped with perforated sieve inserts of selected sizes (such as, for example, 4, 6, 8, 12, 16, and 20 mm, respectively), as is commonly performed in the industry. The mass of particles left on each mesh can be recorded and expressed as a percentage of total weight. In various embodiments, useful hemp hurd can have a relatively small particle size. In some implementations, hemp hurd can have a maximum particle size of about 16 mm, or a particle size distribution (PSD) of about 4 mm to about 16 mm. In some implementations, over 50 wt% of the hemp hurd can have a particle size in a range of about 4 mm to about 16 mm, or over 60 wt% of the hemp hurd can have a particle size in a range of about 4 mm to about 16 mm, or over 70 wt% of the hemp hurd can have a particle size in a range of about 4 mm to about 16 mm, or over 75 wt% of the hemp hurd can have a particle size in a range of about 4 mm to about 16 mm, or 80 wt% or more of the hemp hurd can have a particle size in a range of about 4 mm to about 16 mm.

In some aspects, the relatively small particle size of the hemp hurd can provide one or more beneficial properties to masonry units prepared therefrom, such as increased tensile strength and tensile modulus properties of composite materials, reduced water absorption and structural swelling, and low thermal expansion and lower density, as compared to comparable reinforcing materials.

As illustrated in the Examples, hemp hurd composed of very fine particulate can cause undesirable properties in compositions prepared therefrom. These fine particles can cause cracking, crumbling, and overall reduced mechanical strength of a masonry product formed from these particulates. In some embodiments, biocomposite material comprises no more than about 15 wt%, or no more than about 14 wt%, or no more than about 13 wt%, or no more than about 12 wt%, or no more than about 11 wt%, or no more than about 10 wt%, or no more than about 5 wt% of hemp hurd having a particle size less than about 4 mm. In some implementations, particles having a size less than about 4 mm (such as fiber contaminants) are removed from the hemp hurd prior to mixing with hydraulic lime binder.

In accordance with various implementations, hemp hurd is combined with hydraulic lime binder to prepare a biocomposite material.

Generally speaking, lime binder is prepared by subjecting quarried lime to a series of stages to produce slaked lime. After limestone is mined, it is crushed, screened, and washed before it is heated to between 900° C. and 1000° C. (1652° F. and 1832° F.), a process called calcination. During calcination, the limestone partially decomposes, some amount of CO₂ is released, and limestone (CaCO₃) is converted to lime (CaO).

Suitable lime comprises hydraulic lime. Hydraulic lime has its initial set with water (similar to cement), and a second set by absorption of CO₂.

Hydraulicity is produced by burning and slaking a limestone containing silica, alumina, and iron oxides which above certain temperatures combine, totally or partially, with the calcium oxide (CaO). The resulting silicates, aluminates and ferrites give hydraulic properties to the product.

Suitable Natural Hydraulic Lime can be obtained from TransMineral USA and can comprise free (available) lime Ca(OH)₂ of about 15 wt% or more, or about 20 wt% or more, or about 25 wt% or more, or about 30 wt% or more, or about 40 wt% or more, or about 50 wt% or more. Suitable hydraulic lime contains trace amounts of SO₃, such as about 2 wt% or less, or about 1 wt% or less, or about 0.6 wt% or less. Suitable hydraulic lime contains trace amounts to no potentially damaging components such as tricalcium aluminate (Ca₃Al₂O₆, also referred to as aluminate, or C₃A) and soluble sulphates. Thus, in some implementations, suitable hydraulic lime contains about 2 wt% or less, or about 1 wt% or less, or about 0.6 wt% or less of tricalcium aluminate. In some implementations, suitable hydraulic lime contains about 2 wt% or less, or about 1 wt% or less, or about 0.6 wt% or less of soluble sulphates. Chemical constituents of hydraulic lime (such as available lime, sulfur trioxide, and the like) can be determined by suitable standard techniques, for example ASTM C25-19 (Standard Test Methods for Chemical Analysis of Limestone, Quicklime, and Hydrated Lime).

TransMineral USA offers at least three commercial natural hydraulic lime (NHL) products such as NHL 5, NHL 3.5 and NHL 2 (commonly defined as eminently, moderately, and feebly hydraulic, respectively). Chemical composition of these natural hydraulic lime compositions are as follows:

Composition Chemical (%)

| | NHL5 | NHL 3.5 | NHL 2 |
|---|---|---|---|
| Calcimetry (CaO₂) | 10 | 11 | 6 |
| Insoluble | 5.6 | 9.6 | 8 |
| CaO | 59 | 56 | 63 |
| Al₂O₃ | 1.92 | 1.66 | 1.3 |
| Fe₂O₃ | 0.57 | 0.49 | 0.4 |
| SO₃ | 0.41 | 0.45 | 0.31 |
| MgO | 1.01 | 0.98 | 0.75 |
| MnO | 0.02 | 0.01 | >0.01 |
| TiO₂ | 0.18 | 0.16 | 0.12 |
| K₂O | 0.21 | 0.16 | 0.12 |
| Na₂O | 0.07 | 0.06 | 0.04 |

Illustrative lime binder comprises very fine particles, such as having an average particle size of about 0.08 mm (#200) with low bulk density. In some implementations, suitable hydraulic lime binder comprises particles having an average particle size of about 0.05 mm to about 0.15 mm, or about 0.06 mm to about 0.10 mm, or about 0.07 mm to about 0.09 mm.

In some implementations, a suitable hydraulic lime binder is chosen to provide one or more of the following advantageous features: elasticity, permeability, resistance to salts, suitable compressive strength, resistance to weather, self-healing properties, resistance to bacterial growth, insulation, color, ability to be reworked, recyclability, and CO₂ absorption.

In various aspects, when dried hydraulic lime binder is mixed with hemp and water, a binding process called carbonation takes place. This process is the reverse of calcination, wherein CO₂ is sequestered from the environment and captured in the hempcrete, transforming CaO back to CaCO₃. In some aspects, this carbon sequestration begins during the drying process and continues after the settable formulation has cured to form a masonry unit.

In accordance with some implementations, biocomposite material can include one more additives, such as, but not limited to, nanosized materials such as pozzolans, nanocellulose, and graphene. In some implementations, additives can be included to modify one or more properties of the biocomposite material, such as mechanical, thermal, chemical, and/or electrical properties. In some aspects, additives can be included to provide higher thermal value, potential structural value, or load bearing value to the biocomposite. Optionally, additives can be included to reduce the required time to dry settable formulations.

Suitable pozzolanic materials can include, for example, natural and artificial materials such as biochar (e.g., hemp-based biochar), pozzolanic ash, silica fume, fly ash, rice husk ash, and the like, or a combination of any two or more of these.

Biochar can be obtained from hemp stalks or other biomass. In some implementations, biochar be obtained from a sustainable source of biomass, such as crop residues, non-commercial wood and wood waste, manure, solid waste, non-food energy crops, construction scraps, yard trimmings, methane digester residues, grasses, or a combination of any two or more of these. Biochar can provide benefits such as for example, increased carbon sequestration.

In some aspects, nanocellulose may include cellulose nanocrystals, cellulose nanofibrils, cellulose microfibrils, or a combination of any two or more of these.

The source of the nanocellulose is not particularly limited. In some aspects, the nanocellulose can be obtained from a process involving: fractionating biomass in the presence of an acid catalyst, a solvent for lignin, and water, to generate cellulose-rich solids, hemicelluloses, and lignin; separating the cellulose-rich solids from the hemicelluloses and the lignin; and mechanically refining the cellulose-rich solids to generate the nanocellulose particles.

In some implementations, nanocellulose can be obtained from a process of pretreating biomass in the presence of steam or hot water to generate cellulose-rich solids and hemicelluloses; separating the cellulose-rich solids from the hemicelluloses; and mechanically refining the cellulose-rich solids to generate the nanocellulose particles.

When included, additives can be present in a minimal amount, for example about 5 wt% or less, or about 4 wt% or less, or about 3 wt% or less, or about 2 wt% or less, or about 1 wt% or less of the total biocomposite material. In some implementations, additives can be present in an amount in a range of about 2 wt% to about 5 wt%, or about 3 wt% to about 5 wt% of total biocomposite material.

In some implementations, biocomposite materials do not include sand.

In accordance with various implementations, hemp hurd is combined with hydraulic lime binder to prepare a biocomposite material. This biocomposite material is essentially a dry mix that can be sold, shipped, and stored in a relatively dry state. When the user is ready to prepare masonry units using the biocomposite material, it is combined with liquid (such as water) to form a settable formulation. Additives can either be included in the biocomposite material (dry mix) or added concurrently with water (during preparation of the settable formulation). These aspects will now be described in more detail.

In some implementations, masonry units are prepared by combining hemp-based biocomposite material (hemp hurd and mineral binder) with liquid (e.g., water) to form a settable formulation. One illustrative settable formulation comprises about 20 wt% hemp hurd, about 30 wt% mineral binder, and about 50 wt% water. Thus, in some aspects, a settable formulation can comprise biocomposite material (hemp hurd and mineral binder) in an amount equal to the amount of liquid (e.g., water). These and other optional components will now be described in more detail.

Generally speaking, liquid added to the biocomposite material will change the consistency of the mixture and will thus impact dry times of the material. In accordance with various implementations, the amount of liquid added to biocomposite material can be based on the type and size of hurd material, as well as the identity and/or amount of any optional ingredients included (such as biochar, nanocellulose, and/or graphene).

The liquid phase (e.g., aqueous fluid) with which the dry component may be combined to produce the settable composition may vary, from pure water to water that includes one or more solutes, additives, co-solvents, and the like, as desired. The weight ratio of dry component to liquid phase that is combined in preparing the settable composition may vary, and in certain embodiments can range from about 1:1 to about 1:1.5, or about 1:1.1 to about 1:1.2.

In some implementations, hemp-based biocomposite material is prepared by mixing 450 g hemp hurd with 608 g hydraulic lime binder. Water in an amount of 1250 g is then added, and the combination is mixed for a sufficient amount of time so that the completed admixture can be compacted to a ball. The particular ratio of hemp hurd, hydraulic lime binder, and water can be selected to maximize structural strength and optimize drying times for a masonry unit.

In various aspects, mixing of the hemp hurd and hydraulic lime binder can be performed in paddle or drum mixers. In some implementations, when using paddle mixers, hemp hurd is introduced first. While turning, the hemp hurd can be sprayed with water mist until the hurd is damp (this can be observed as a change in color of the hurd). Next, the hydraulic lime binder can be introduced into the mixer, and water can be misted until a homogenous mix is obtained. In some implementations, total mixing time can be about 5 to about 10 minutes. In some implementations, when using drum mixers, hydraulic lime binder and water can be introduced into the mixer and mixed for about 3 to 5 minutes to obtain a milky paste with no lumps. Loose hemp hurd is then added, followed by mixing for an additional time, such as about 5 minutes, to obtain a desired consistency. The remainder of water is then added. The completed mix is relatively dry and lean. In these aspects, total mixing time can be about 8 to about 10 minutes.

In some implementations, once mixed, the settable formulation is provided to molds and compacted. The combined hemp hurd/hydraulic lime binder/water mixture is introduced into molds. In some implementations, the mixture can be placed in layers of about 4 inches to about 6 inches and compacted before an additional layer is introduced. This incremental addition can be repeated until the mold is filled.

In some implementations, a vibro-compression mold system can be utilized, such as commercially available from Global Machine Market (Overland Park, KS). Illustrative vibro-compression mold systems can include a bolt-in, replaceable component mold system that includes a two-section design. The upper section comprises a press head which is a set of steel plungers, while the lower section comprises the steel mold box. The bolt-in design of the mold box allows internal parts to be replaced once they wear outside the acceptable product tolerances without replacing the entire mold, providing a more efficient and cost-effective manufacturing process. The mold box can include several bolt-in replaceable mold wear liners that determine the outer shape of the block, while the inner liner can provide the shape of the other side of the block. In use, the lower mold cavity can be filled with the hemp-based composition, the upper press head is lowered into the open cavities of the mold box, and the molds are vibrated. The combination of specific pressure and vibration can ensure consistent height and density of the masonry units. In various implementations, masonry units are allowed to set for about 30 minutes before removing the molds and moving the units (blocks, bricks, etc.) to pallets for drying/curing.

In various implementations, the masonry units can be dried at ambient environmental conditions, for example about 60° F. to about 80° F. and about 60% to about 80% humidity, or about 65° F. to about 75° F. and about 65% to about 75% humidity, or about 70° F. and about 70% humidity. It is understood that the particular environmental conditions of use may impact the amount of time to dry the masonry units. In some implementations, masonry units can be dried at temperatures and humidity levels outside of the ranges listed for “ambient” conditions above. Masonry units can be dried until the moisture content is relatively stable, for example, 29 days or less, or 28 days or less, or 27 days or less, or 26 days or less, or 25 days or less.

Materials Testing - Desired properties. For materials testing, masonry units (e.g., bricks) can be cut into equal sized portions (e.g., cylinders), to assess uniformity of the formulation mixture throughout the brick. Mechanical testing can be conducted using Universal testing machines (UTM) designed and manufactured by the Instron company. Testing methods can meet or exceed the requirements of ASTM Standards for concrete masonry units and related units including ASTM C140 and ASTM C426 (ASTM, 2020). Lime carbonation kinetics can be determined using X-ray diffraction.

For structural testing, density and linear dimensions of the masonry units are checked at multiple intervals during the drying phase and after curing and carbonation (when relevant) is complete. Compression testing can be conducted with the UTM, and force and relative displacement can be assessed in MPa to calculate stress (σ) using the equation:

$$\text{σ} = \frac{\text{F}}{\text{A}}$$

where F is force in Newtons (N) while A is the cross-sectional area of a given sample. Strain is calculated by dividing the displacement by the original height of the test sample. Specimens can then be submerged in water for 24 hours, and the saturated samples placed in a freezer and subjected to multiple free-thaw cycles, then tested again for compression strength using the same force and displacement measures. Water sorption is tested by placing specimens in water and measuring the weight at twelve fixed intervals between 0 and 2,000 and then using the results todetermine the water sorption coefficient. Tensile strength can be tested by applying a linear load to samples with the UTM, and calculating splitting tensile strength (T) in MPa using the equation:

$$\text{T} = \frac{\text{2Fmax}}{π \text{dl}}$$

where Fmax is the maximum strength at failure (N), and d is the diameter (mm) and 1 the length (mm) of a cylinder.

Thermal testing can be performed by constructing wall sections, with whole bricks and mortar, which are placed inside a double-room climatic chamber and then subjected to a range of temperatures simulating indoor and outdoor environments as well as winter and summer settings. Heat exchanged between environments call also be used to assess the thermal efficiency of wall sections.

The mineral content of the lime binding and coating provides fire resistance for the fibrous hurd material. Fire resistance testing can be conducted in accordance with ASTM E119-14 and CAN/ULC S101-07 standards. Alternatively, fire resistance testing can use an open flame from a gas burner rated for up to 1800° F. and an infrared camera that can monitor temperature distribution within a brick.

In some aspects, masonry units can exhibit thermal resistance R 0.9 per inch or greater, or 1.0 per inch or greater, or R 1.5 per inch or greater, or R 1.8 per inch or greater, or R 2.0 per inch or greater, or R 2.1 per inch or greater, or R 2.2 per inch or greater, or R 2.3 per inch or greater, or R 2.4 per inch or greater, a net improvement over traditional façade wall systems with the current standard of masonry brick at R 0.2 to R 0.7 per inch. In some implementations, masonry units can exhibit thermal resistance R 2.4 per inch.

In some implementations, masonry units can exhibit thermal resistance R 2.4 per inch while maintaining compressive strength of about 100 kPa to about 500 kPa, or about 200 kPa to about 400 kPa, or about 250 kPa to about 350 kPa, or about 300 kPa; flexural resistance of about 100 kPa to about 400 kPa, or about 150 kPa to about 350 kPa, or about 150 kPa to about 250 kPa, or about 230 kPa, and superior water vapor resistance as determined by sorption testing.

In use, masonry units can be provided in a novel, notched design that accommodates Optimum-value Engineering (OVE) standards that recommend joint, stud, and rafter spacing for American construction. These standards are set to improve thermal performance, reduce the amount of wood needed to build a structure, and decrease construction waste.

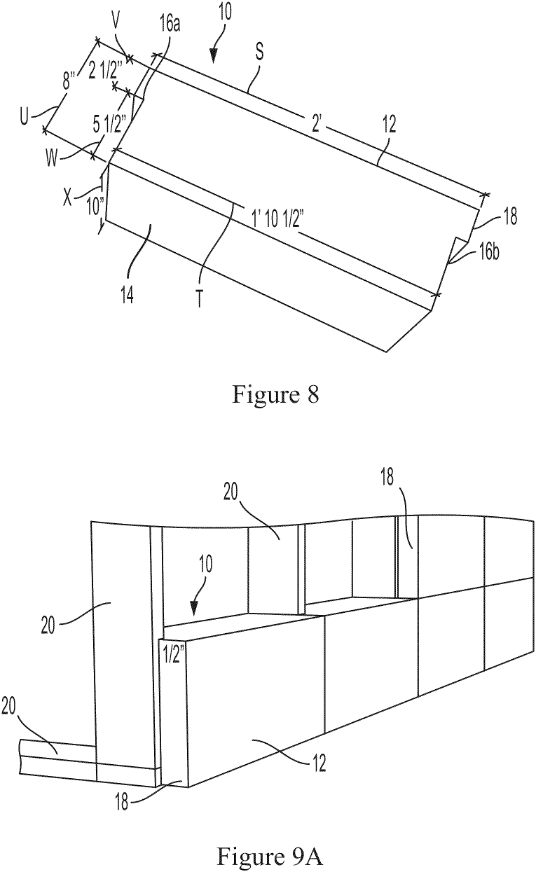

An illustrative notched design in accordance with some embodiments is shown in FIG. 8, which illustrates a masonry unit 10 provided as a brick having dimensions optimized for 24-inch on center 2×6 framing. As shown, a masonry unit 10 has a front surface 12, a rear surface 14, a first side surface 16a and an opposing second side surface 16b, wherein the front surface 12 comprises a larger surface area than the rear surface 14, and the first side surface 16a and second side surface 16b each include a shoulder 18. As shown, dimensions of the brick can be as follows: the front surface 12 can have a length (S) of 24 inches, the rear surface 14 can have a length (T) of 22.5 inches, and opposing side surfaces 16a and 16b can have a length (U) of 8 inches, wherein shoulder 18 has a length (V) of 2.5 inches, leaving a length (W) of 5.5 inches along the recessed face of side surfaces 16a and 16b. The height (X) of the illustrated brick is 10 inches. In these embodiments, when used in connection with framing members spaced 24 inches apart, the rear surface 14 of the brick will be flush with the surface of the framing members. The blocks can thus supply 8 inches of hemp-based biocomposite insulation between 2×6 studs on 2-foot centers with walls that are 8 feet high and provide a 2.5 inch covering over the studs themselves. These dimensions can provide a useful guide when adapting masonry units for other applications.

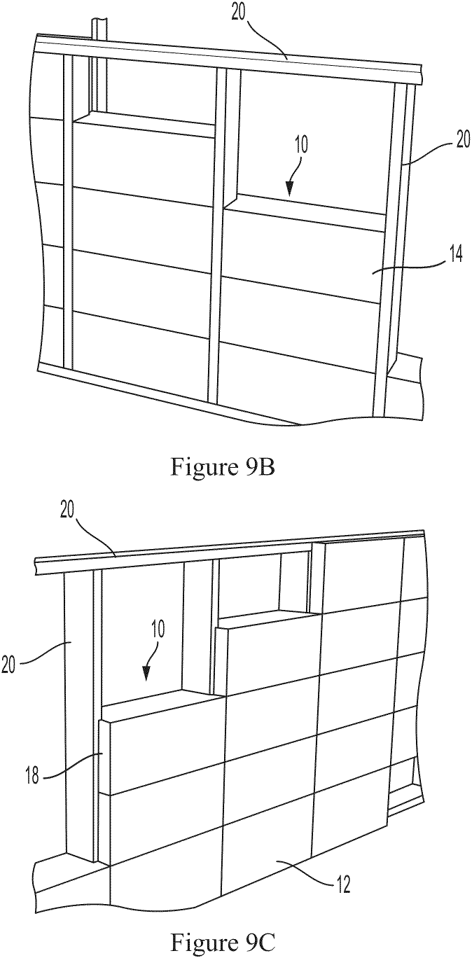

FIGS. 9A through 9C illustrate masonry units 10 assembled between studs or frame 20 of a building. Each block is inserted between the studs or frame 20 of the building structure one by one. Each block includes mineral based mortar to secure its position.

Any suitable mortar may be used to secure blocks in an assembly. In some implementations, lime mortar having similar properties to the hydraulic lime binder may be particularly useful.

Optionally, a plaster or other final coating material may be applied to the installed masonry units, preferably after the masonry units have dried. In some implementations, the plaster or other final coating is vapor permeable. One final coating that can find particular use is REAL MILK PAINT®, a powdered, organic, non-toxic paint, commercially available from The Real Milk Paint Co. (Hohenwald, TN).

In some aspects, masonry units and settable compositions find use in a variety of applications, particularly as building or construction materials. Illustrative structures in which the settable compositions can be used include, but are not limited to, architectural structures such as buildings, foundations, brick/block walls, and the like.

In some aspects, masonry units can find use in reducing the amount of CO₂ that is generated in producing buildings and then operating buildings. Specifically, in various aspects, methods described herein can reduce CO₂ generation during production of building materials.

Methods and systems in accordance with various implementations may also find use in CO₂ sequestration, particularly via sequestration in the built environment. Sequestering CO₂ comprises removal or segregation of CO₂ from the atmosphere and fixating it into a stable non-gaseous form. In various aspects, CO₂ sequestration comprises the uptake of CO₂ into a storage stable form, e.g., as components of the built environment, such as a building. By storage stable form is meant a form of matter that can be stored above ground under exposed conditions (open to the atmosphere) without significant, if any, degradation for extended durations, such as a year or longer, 5 years or longer, 10 years or longer, 25 years or longer, 50 years or longer, 100 years or longer, etc. Thus, in some aspects, CO₂ that is removed from the atmosphere and stored in masonry units described herein can remain in the masonry units for a year or longer, or 5 years or longer, or 10 years or longer, or 25 years or longer, or 50 years or longer, or 100 years or longer, etc. Storage of CO₂ within the masonry units can be measured as the amount of CO₂ gas released from the product over time. In some aspects, sequestration and storage of CO₂ within masonry units can be measured by chemical analysis of the units, e.g., through suitable standard techniques, for example ASTM C25-19. As the storage stable form undergoes little if any degradation while stored, the amount of degradation (if any) as measured in terms of CO₂ gas release from the product will typically not exceed 5% per year, and in certain embodiments will not exceed 1% per year. Storage stable forms may be storage stable under a variety of environmental conditions, e.g., from temperatures ranges of about -100° C. to about 600° C., humidity ranging from about 0 to about 100%, where the conditions may be calm, windy, turbulent, or stormy.

In some aspects, compositions and masonry units described herein can sequester more carbon than is emitted in other parts of the lime cycle. For example, in some implementations, a 1 m x 1 m x 0.3 m hemp and lime wall can sequester about 82.71 kg CO₂, while the growing, lime processing, manufacturing, and construction typically uses about 46 kg CO₂, thus storing a net amount of about 36.71 kg of environmental CO₂. As hempcrete cures, the hardening kinetics can continue the uptake of ambient carbon over weeks and even years. In some aspects, hemp-based masonry units can sequester and store CO₂ for 5 years or longer, 10 years or longer, 25 years or longer, 50 years or longer, or 100 years or longer.

### EXAMPLES

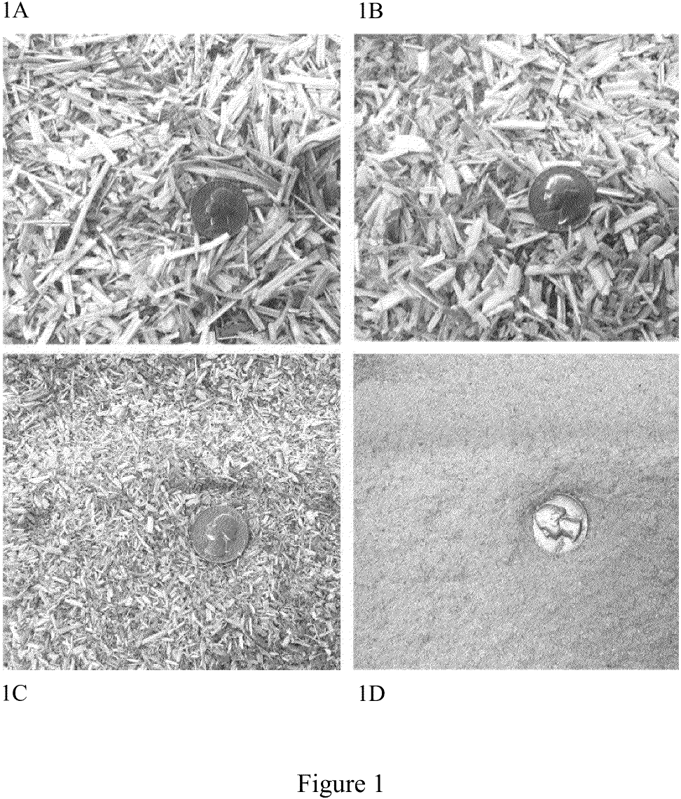

Example 1. Formulation of Hemp-based Blocks. Hemp-based blocks were prepared by combining hydraulic lime binder with four different hemp hurd types. Hurd types were obtained and utilized from four vendors, as specified in Table 1 and illustrated in FIG. 1.

TABLE 1

Vendors and Hurd Types

| | | | | |
|---|---|---|---|---|
| | Type 1 | Type 2 | Type 3 - Micro | Type 4 - Dust |
| Vendors | The Hempville, Inc., Siler City, North Carolina | Montana | Colorado | Colorado |
| Particle size distribution | >75% 4 mm to 16 mm | >75% 4 mm to 16 mm | 0.06 mm | Approx. 0.001 mm (micron) |
| Figure | 1A | 1B | 1C | 1D |

Hemp hurd can be procured from several providers in the US and Canada, including The Hempville, Inc. and Western Fiber (Hollis, OK). Processing of hemp biomass is done through a decorticator, cotton gins, or manually. The hydraulic lime binder used is commercially available from LimeWorks.us under the brand name Ecologic™ Hempcrete Binder Platinum. The binder comprised hydraulic lime mined in France.

For lab fabrication and testing, half-size blocks were manufactured in order to reduce drying times and conserve materials. Molds were fabricated from plywood to produce blocks measuring 11 × 5 × 4 inches in dimension.

To prepare masonry units (blocks), 450 g of hemp hurd (Types 1 - 4, Table 1) were combined with 680 g Ecologic™ Hempcrete Binder Platinum, and the combination was mixed using a motorized mortar mixer in a 5-gallon bucket. By premixing dry ingredients, fiber contaminants in the hurd (e.g., particle sizes less than 4 mm) were observed to wrap around the mixer shaft and were thus easily removed. After removal of fiber contaminants, 1250 g water was added and mixing continued until the composition achieved a suitable consistency.

The composition was then poured into molds and manually compressed.

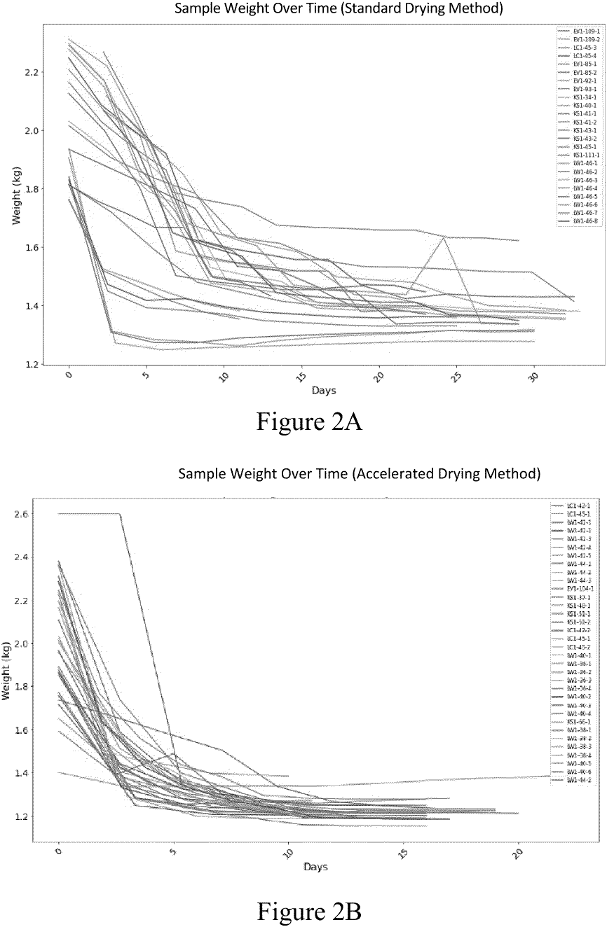

Molded blocks were then dried at conditions that simulated average ambient room temperature and humidity (approximately 70° F. and 70% relative humidity) for the times indicated in Table 2 (Standard Drying Method, or “Standard”). To determine when a block was sufficiently dried, each block was weighed on a daily basis, and block weight was plotted versus time (FIG. 2A). A slope of zero, or reasonably close to zero, was taken as the dry point, since further drying would not change the result.

Data representing density, drying time and block shrinkage are illustrated in Table 2.

TABLE 2

Density, drying time, and shrinkage

| Sample | Density (kg/m³) | Drying Time (days) | Shrinkage (%) | Sample | Density (kg/m³) | Drying Time (days) | Shrinkage (%) |
|---|---|---|---|---|---|---|---|
| EV1-104-1 | 366.70 ± 74.00 | 16 | -0.85 | LW1-36-3 | 343.02 ± 38.33 | 16 | -0.62 |
| EV1-109-1 | 431.46 ± 68.49 | 23 | 1.59 | LW1-36-4 | 358.07 ± 35.41 | 16 | -2.84 |
| EV1-109-2 | 427.16 ± 61.53 | 23 | -0.31 | LW1-38-1 | 370.81 ± 67.74 | 13 | -1.3 |
| EV1-85-1 | 344.81 ± 26.24 | 24 | 7.44 | LW1-38-2 | 374.91 ± 62.28 | 13 | -5.13 |
| EV1-85-2 | 321.69 ± 16.00 | 24 | 4.66 | LW 1-3 8-3 | 330.98 ± 10.58 | 13 | -0.03 |
| EV1-92-1 | 364.92 ± 26.50 | 11 | -1.87 | LW 1-3 8-4 | 375.95 ± 48.96 | 16 | -3.16 |
| EV1-93-1 | 379.03 ± 40.76 | 11 | -1.92 | LW 1-40-1 | 372.45 ± 84.87 | 16 | 1.18 |
| KS1-111-1 | 420.68 ± 35.83 | --- | --- | LW 1-40-2 | 362.81 ± 53.53 | 16 | -6.06 |
| KS 1-34-1 | 320.87 ± 16.57 | 24 | 1.68 | LW 1-40-3 | 409.48 ± 81.98 | 16 | -2.01 |
| KS01-37-1 | 320.56 ± 14.16 | 14^{∗} | --- | LW1-40-4 | 361.10 ± 74.67 | 12 | -2.03 |
| KS1-40-1 | 324.74 ± 46.55 | 12 | 1.42 | LW 1-40-5 | 381.65 ± 76.58 | 12 | -4.35 |
| KS1-41-1 | 308.73 ± 39.99 | 12 | 6.23 | LW1-40-6 | 435.59 ± 118.52 | 12 | -3.66 |
| KS1-41-2 | 318.38 ± 49.12 | 12 | 5.71 | LW 1-42-1 | 367.59 ± 77.99 | 10 | -1.12 |
| KS1-43-1 | 335.37 ± 32.87 | 25 | 0.79 | LW 1-42-2 | 350.97 ± 66.92 | 10 | -0.47 |
| KS1-43-2 | 337.51 ± 28.46 | 25 | -4.39 | LW 1-42-3 | 370.36 ± 78.42 | 10 | -1.07 |
| KS1-45-1 | 354.21 ± 36.38 | 22 | 0.03 | LW 1-42-4 | 349.90 ± 61.59 | 10 | 0.55 |
| KS1-48-1 | 310.41 ± 7.38 | 17 | -1.63 | LW 1-42-5 | 409.52 ± 79.63 | 10 | -0.23 |
| KS1-51-1 | 351.59 ± 54.77 | 11 | -2.63 | LW 1-44-1 | 325.68 ± 79.83 | 17 | -0.34 |
| KS1-51-2 | 338.09 ± 53.60 | 11 | -0.58 | LW 1-44-2 | 345.47 ± 89.60 | 17 | 0.02 |
| KS1-66-1 | 468.60 ± 125.02 | 12 | -3.84 | LW 1-44-3 | 315.46 ± 77.60 | 17 | -1.32 |
| LC 1-42-1 | 360.21 ± 103.00 | 16 | -0.59 | LW 1-46-1 | 342.75 ± 70.47 | 28 | 0.21 |
| LC 1-42-2 | 411.54 ± 171.08 | 16 | 0.08 | LW1-46-2 | 353.84 ± 69.30 | 28 | -0.65 |
| LC 1-45-1 | 326.06 ± 73.97 | 16 | -0.22 | LW 1-46-3 | 355.49 ± 71.48 | 28 | -1.19 |
| LC 1-45-2 | 351.31 ± 74.72 | 16 | -0.45 | LW1-46-4 | 412.11 ± 80.02 | 32 | 0.18 |
| LC 1-45-3 | 422.98 ± 71.40 | 23 | 0.08 | LW 1-46-5 | 384.85 ± 65.81 | 29 | 0.68 |
| LC 1-45-4 | 422.07 ± 69.20 | 23 | -0.05 | LW 1-46-6 | 397.33 ± 62.34 | 29 | -0.22 |
| LW1-36-1 | 390.82 ± 104.16 | 14 | -1.96 | LW1-46-7 | 417.45 ± 47.22 | 29 | -0.52 |
| LW1-36-2 | 400.35 ± 95.72 | 14 | -4.05 | LW 1-46-8 | 380.80 ± 58.24 | 29 | 0.07 |

^{∗} indicates estimated value

In addition, a subset of samples were dried using an accelerated drying method in an environmental chamber set at 90° F. and 30% relative humidity (Accelerated Drying Method, or “Accelerated”). To determine when a block was sufficiently dried, each block was weighed on a daily basis, and block weight was plotted versus time (FIG. 2B). A slope of zero, or reasonably close to zero, was taken as the dry point, since further drying would not change the result.

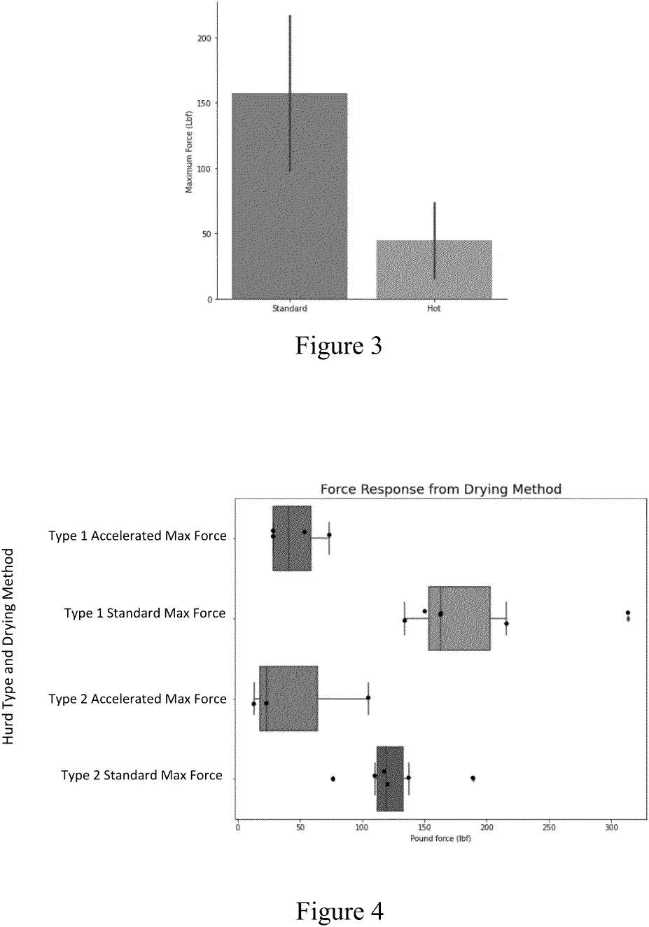

It was observed that the attempt at accelerated drying was not successful since the flexural strength of the blocks was significantly lower than observed for blocks cured at the conditions of the Standard Drying Method. FIG. 3 illustrates flexural test results (maximum force, pounds force, lbf) for the Standard Drying Method versus the Accelerated (“Hot”) Drying Method. The data of FIG. 3 is also shown below in Table 3. Flexural strength was determined using 3-Point Bend testing in accordance with ASTM C140/C140M-20a (Standard Test Methods for Sampling and Testing Concrete Masonry Units and Related Units).

TABLE 3

Flexural strength of blocks - comparison of Standard Drying Method vs Accelerated Drying Method

| Drying Method | Mean (Ibf) | Standard Deviation (Ibf) | Standard Error (Ibf) |
|---|---|---|---|
| Standard | 158 | 61 | 18 |
| Accelerated | 45 | 31 | 11 |

Data illustrate that blocks prepared using the Standard Drying Method possessed superior flexural strength, as compared to blocks prepared using the Accelerated Drying Method.

Example 2. Density and Mechanical Properties. The density and mechanical properties of the hemp-based blocks prepared in Example 1 were determined as follows.

The density of the hemp hurd (starting material) was measured separately and found to be 263 ± 47 kg/m³. Separately, mineral binder was mixed with water and dried to determine the hydration uptake of the binder during curing. It was observed that the binder adsorbed 17% of water and exhibited a cured density of 1128 kg/m³. Using these values and the density of the cured block itself, the porosity of the block was calculated using the equations below:

$$\text{Vs} = {\text{V}}_{\text{w}} + {\text{V}}_{\text{a}} + {\text{V}}_{\text{m}} \qquad \text{(Equation 1)}$$

where
Vₛ = Volume of solid
V_{w} = Volume of water
Vₐ = Volume of air, and
Vₘ = Volume of material
where

$${V}_{h u r d} = \frac{{m}_{h u r d}}{{ρ}_{h u r d}} ; {V}_{b i n d e r} = \frac{{m}_{b i n d e r}}{{ρ}_{b i n d e r}}$$

where
m_{hurd} = mass of hurd
ρ_{hurd} = density of hurd
m_{binder} = mass of cured binder
ρ_{binder} = density of binder

To determine the mass of the cured binder, several neat binder samples were cured and the density measured. The increase in weight of the binder upon curing is due to hydration of the binder. This allowed the following relationship to be used:

$${m}_{b i n d e r} = c ⋅ {m}_{b i n d e r d r y}$$

where c is a constant ratio between the mass of the cured binder and the dry binder that is mixed into the individual masonry block. Its value was determined to be c = 1.17 ± 0.01. Thus,

$$ϕ \text{=} {V}_{w} \text{+} {V}_{A} {V}_{s} \qquad \text{(Equation 2)}$$

After the binder in the masonry block cured, the volume of the water was assumed to be negligible. Therefore,

$$ϕ = \frac{{V}_{A}}{{V}_{s}}$$

where V_{S} = V_{block}; V_{A} - V_{block} - V_{hurd} - V_{binder}

Therefore, porosity is rewritten as:

$$ϕ = \frac{{V}_{b l o c k} - {V}_{h u r d} - {V}_{b i n d e r}}{{V}_{b l o c k}}$$

Simplifying to

$$ϕ = 1 - \frac{{V}_{h u r d} + {V}_{b i n d e r}}{{V}_{b l o c k}}$$

After further substitution, Equation 2 becomes

$$ϕ = 1 - \frac{\frac{{m}_{h u r d}}{{ρ}_{h u r d}} + \frac{c ⋅ m}{{ρ}_{b i n d e r}}}{{V}_{b l o c k}} \qquad \text{(Equation 3)}$$

Porosity. Values for porosity are reflected in Table 4 below. In some embodiments, porosity of the masonry units can be in a range of about 0.2 to about 0.6, or in a range of about 0.3 to about 0.5, or in a range of about 0.3 to about 0.46.

TABLE 4

Porosity

| Sample | Type | Coated/Not Coated | TRMS (Rvalue/in) | Porosity |
|---|---|---|---|---|
| LW1-42-1 | 1 - North Carolina | Not Coated | 1.795 | 0.367 |
| LW 1-42-3 | 1 - North Carolina | Not Coated | 1.88 | 0.356 |
| LW 1-42-4 | 1 - North Carolina | Not Coated | 1.678 | 0.383 |
| LW 1-42-5 | 1 - North Carolina | Not Coated | 1.491 | 0.368 |
| LW1-46-4 | 1 - North Carolina | Not Coated | 1.595 | 0.402 |
| EV1-104-1 | 2 - Montana | Not Coated | 1.7 | 0.36 |
| EV1-85-1 | 2 - Montana | Coated | 1.35 | 0.452 |
| EV1-92-1 | 2 - Montana | Not Coated | 1.161 | 0.43 |
| KS 1-37-1 | 2 - Montana | Coated | 1.766 | 0.434 |
| KS 1-43-1 | 2 - Montana | Not Coated | 1.241 | 0.411 |
| KS 1-43-2 | 2 - Montana | Not Coated | 1.189 | 0.426 |
| KS 1-48-1 | 2 - Montana | Coated | 1.753 | 0.415 |
| KS 1-51-2 | 2 - Montana | Not Coated | 1.133 | 0.408 |
| LC1-42-2 | 2 - Montana | Not Coated | 1.839 | 0.393 |
| LC1-45-1 | 2 - Montana | Not Coated | 1.469 | 0.447 |
| LC1-45-2 | 2 - Montana | Not Coated | 1.737 | 0.435 |
| LW 1-44-1 | 2 - Montana | Not Coated | 1.77 | 0.429 |
| LW 1-44-2 | 2 - Montana | Not Coated | 1.94 | 0.417 |
| LW1-36-1 | 3 - Fine | Not Coated | 1.822 | 0.319 |
| KS 1-66-1 | 4 - Extra fine | Not Coated | 1.437 | 0.189 |
| LW1-38-2 | 4 - Extra fine | Not Coated | 1.662 | 0.34 |

Thermal performance. While data on porosity was obtained, it did not correlate well with R value. It was concluded that heat transfer in the produced blocks was primarily by conduction, not convection. Therefore, the thermal conductivity depended primarily upon the amounts of binder and hurd (assuming the blocks were thoroughly dry at testing, which was measured, Table 5). Additional variability in thermal values was a result of a lack of flatness of the block surface and less than parallel platen contact sides in the Thermal Resistance Measuring System (TRMS) employed.

The TRMS was custom built by Oklahoma State University and closely resembled the standard ASTM (Standard C 1919) device for measuring thermal properties. Prior to use, the TRMS was calibrated using commercial products. As a result of surface irregularities in the blocks formed, complete contact between the block and platens was not achieved.

The thermal values of the produced blocks are summarized in Table 5. Results indicated the thermal values of produced blocks were surprisingly stable, with R-values in the range of 1 to 2 per inch. These manually prepared blocks on a laboratory scale can be adjusted as the process is mechanized, and varied density can obtain different thermal insulation values.

TABLE 5

Hurd Type, R-value, and Dry Method of Each Block

| Sample | Type | Coated/Not Coated | TRMS (Rvalue/in) | Dry Method |
|---|---|---|---|---|
| LW1-42-1 | 1 - North Carolina | Not Coated | 1.795 | Accelerated |
| LW 1-42-3 | 1 - North Carolina | Not Coated | 1.88 | Accelerated |
| LW 1-42-4 | 1 - North Carolina | Not Coated | 1.678 | Accelerated |
| LW 1-42-5 | 1 - North Carolina | Not Coated | 1.491 | Accelerated |
| EV1-104-1 | 2 - Montana | Not Coated | 1.7 | Accelerated |
| KS1-37-1 | 2 - Montana | Coated | 1.766 | Accelerated |
| KS 1-48-1 | 2 - Montana | Coated | 1.753 | Accelerated |
| KS 1-51-2 | 2 - Montana | Not Coated | 1.133 | Accelerated |
| LC 1-42-2 | 2 - Montana | Not Coated | 1.839 | Accelerated |
| LC1-45-1 | 2 - Montana | Not Coated | 1.469 | Accelerated |
| LC 1-45-2 | 2 - Montana | Not Coated | 1.737 | Accelerated |
| LW 1-44-1 | 2 - Montana | Not Coated | 1.77 | Accelerated |
| LW 1-44-2 | 2 - Montana | Not Coated | 1.94 | Accelerated |
| LW1-36-1 | 3 - Micro | Not Coated | 1.822 | Accelerated |
| KS 1-66-1 | 4 - dust | Not Coated | 1.437 | Accelerated |
| LW1-38-2 | 4 - dust | Not Coated | 1.662 | Accelerated |
| LW 1-26-3 | 1 - North Carolina | Coated | 1.175 | Standard |
| LW 1-30-3 | 1 - North Carolina | Coated | 2.057 | Standard |
| LW 1-34-1 | 1 - North Carolina | Coated | 0.67 | Standard |
| LW1-46-4 | 1 - North Carolina | Not Coated | 1.595 | Standard |
| EV1-85-1 | 2 - Montana | Coated | 1.35 | Standard |
| EV1-92-1 | 2 - Montana | Not Coated | 1.161 | Standard |
| KS1-43-1 | 2 - Montana | Not Coated | 1.241 | Standard |
| KS1-43-2 | 2 - Montana | Not Coated | 1.189 | Standard |

Surprisingly, the thermal properties of the small particle sized hurd (micro and dust) were similar to NC and MT, the larger sizes. However, the small sizes had little to no mechanical strength and crumbled during handling. Some samples exhibited severe cracking during drying (see Table 6).

Flexural strength was determined using 3-Point Bend testing in accordance with ASTM C140/C140M-20a (Standard Test Methods for Sampling and Testing Concrete Masonry Units and Related Units). Results are shown in Table 6, and FIGS. 4-6.

TABLE 6

Flex Test Results of Samples

| Sample | Type | Dry Method | Maximum Force (lbf) |
|---|---|---|---|
| LW1-36-4 | 3 - Fine | Accelerated | 34.25 |
| LW1-44-2 | 1 - North Carolina | Accelerated | 28.54 |
| LC1-45-1 | 2 - Montana | Accelerated | 23.20 |
| LC1-42-2 | 2 - Montana | Accelerated | 13.04 |
| KS1-51-1 | 2 - Montana | Accelerated | 104.96 |
| LW1-42-4 | 1 - North Carolina | Accelerated | 53.77 |
| LW1-42-5 | 1 - North Carolina | Accelerated | 73.67 |
| LW1-44-2 | 1 - North Carolina | Accelerated | 28.54 |
| KS1-31-2 | 2 - Montana | Standard | 120.43 |
| KS1-31-1 | 2 - Montana | Standard | 137.38 |
| KS1-40-1 | 2 - Montana | Standard | 110.19 |
| LW1-26-2 | 1 - North Carolina | Standard | 162.82 |
| LW1-46-1 | 2 - Montana | Standard | 76.65 |
| LW1-34-3 | 1 - North Carolina | Standard | 163.36 |
| LW1-34-1 | 1 - North Carolina | Standard | 134.25 |
| LW1-30-3 | 1 - North Carolina | Standard | 313.50 |
| LW1-30-1 | 1 - North Carolina | Standard | 216.01 |
| LW1-28-3 | 1 - North Carolina | Standard | 150.37 |
| EV1-93-1 | 2 - Montana | Standard | 117.70 |
| EV1-85-2 | 2 - Montana | Standard | 188.93 |

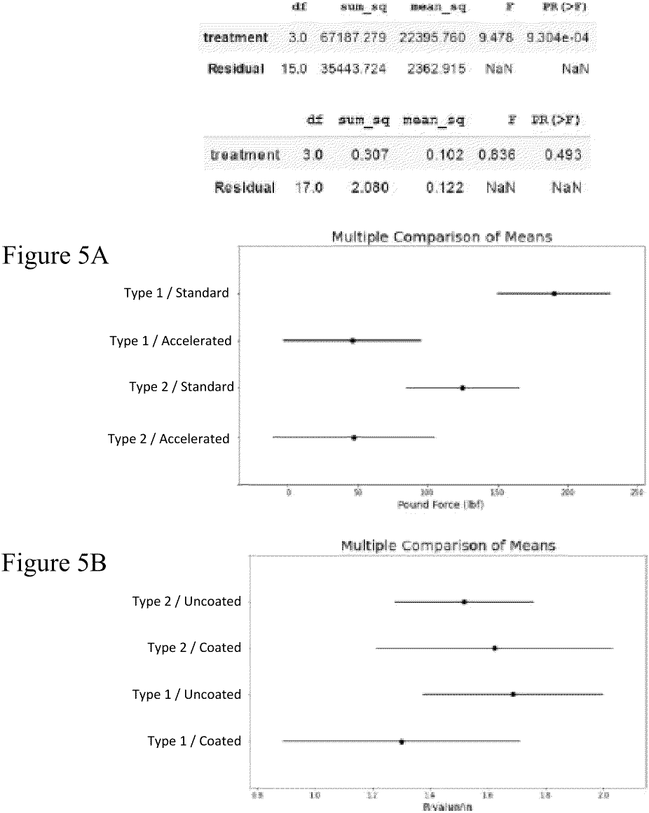

Results indicate that both the thermal properties (Table 5) and flexural strength properties (FIG. 5) of the MT and NC hurd were statistically equivalent. It is anticipated that the observed variability in these values will be reduced with the implementation of automated production methods. Samples shown in FIG. 5B were coated with REAL MILK PAINT®, a powdered, organic, non-toxic paint, commercially available from The Real Milk Paint Co. (Hohenwald, TN).

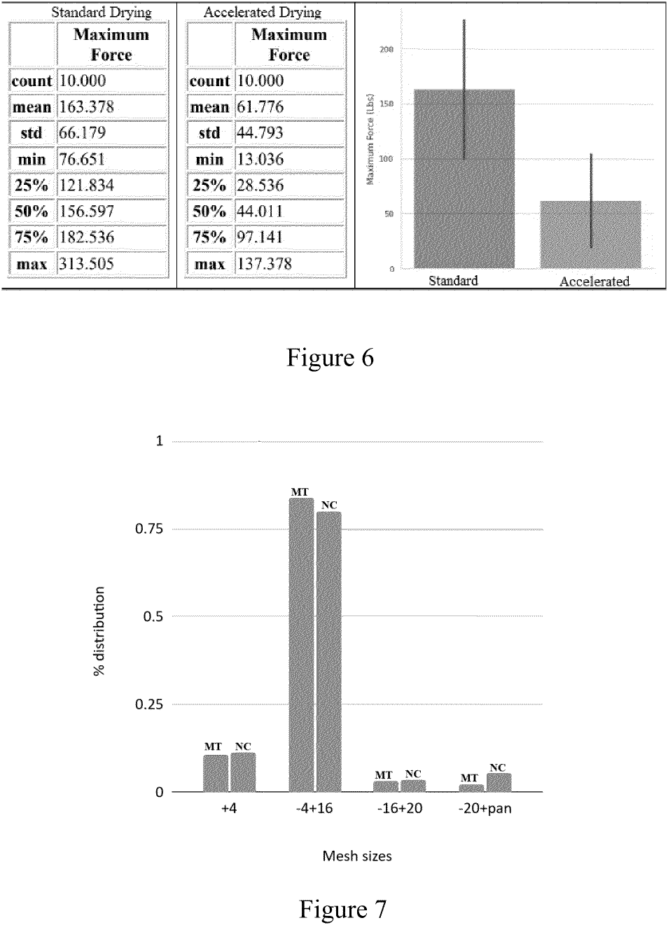

As can be seen in FIG. 6, blocks produced using the Accelerated Drying Method had an average flexural strength that was less than half of that of blocks produced using the Standard Drying Method. Flexural strength properties were significant, particularly given the relatively small brick size tested.

Example 3. Hurd Particle Size Distribution. The particle size distribution of the Type 1 (NC, North Carolina) and Type 2 (MT, Montanta) hurd was measured using a sieve stack and shaker. The sieve sizes selected were 4, 16, and 20. While small differences were observed in the distribution (FIG. 7), based on the other tests which showed no or negligible statistical differences between MT and NC, it was concluded that these two materials were interchangeable. As noted herein, fiber contaminants were removed from the hurd prior to block manufacture, which assisted in achieving this particle size distribution.

Unless otherwise indicated, all numbers expressing dimensions, quantities, feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained. In this application, the use of the singular includes the plural unless specifically stated otherwise, and the use of the terms “and” and “or” means “and/or” unless otherwise indicated. Moreover, the use of the term “including,” “includes,” and “included” should be considered non-exclusive. Unless stated otherwise, percentages and ratios are by weight.

In the specification and in the claims, the terms “including” and “comprising” are open-ended terms and should be interpreted to mean “including, but not limited to....” These terms are broader than, and therefore encompass, the more restrictive terms “consisting essentially of” and “consisting of.”

As used herein and in the appended claims, the singular forms “a,” “an,” and “the” include plural reference unless the context clearly dictates otherwise. As such, the terms “a” (or “an”), “one or more” and “at least one” can be used interchangeably herein.

We claim:

1. A masonry unit comprising hydraulic lime binder and hemp hurd in a hydraulic lime binder:hemp hurd ratio of 1.4:1 to 1.6:1 by weight,
wherein the hydraulic lime binder comprises less than 1% by weight of each of potassium oxide (K₂O), sodium oxide (Na₂O), and sulfur trioxide (SO₃), based on total weight of the hydraulic lime binder, and
wherein the masonry unit comprises a front surface, a rear surface, a first side surface and an opposing second side surface, wherein the front surface comprises a larger surface area than the rear surface, and the first side surface and second side surface each include a shoulder.

2. The masonry unit of claim 1 wherein at least 75% of the hemp hurd has a particle size in a range of 4 mm to 16 mm.

3. The masonry unit of claim 1 wherein the hydraulic lime binder comprises free lime, Ca(OH)₂, in an amount of 15% by weight or more.

4. The masonry unit of claim 1 wherein the hydraulic lime binder comprises particles having an average particle size in a range of 0.05 mm to 0.10.

5. The masonry unit of claim 1 further comprising one or more of biochar, nanocellulose, and graphene.

6. The masonry unit of claim 1 having a porosity in a range of 0.3 to 0.5.

7. The masonry unit of claim 1 having a density in a range of 300 kg/m³ to 500 kg/m³.

8. The masonry unit of claim 1 having a thermal resistance in a range of R 1 to R 2.5 per inch.

9. The masonry unit of claim 1 in the form of a brick or block.

10. A biocomposite material comprising hydraulic lime binder and hemp hurd in a hydraulic lime binder:hemp hurd ratio of 1.4:1 to 1.6:1, wherein the hydraulic lime binder comprises less than 1% by weight of each of potassium oxide (K₂O), sodium oxide (Na₂O), and sulfur trioxide (SO₃), based on total weight of the hydraulic lime binder.

11. The biocomposite material of claim 10 further comprising one or more of biochar, nanocellulose, and graphene.

12. A settable formulation comprising the biocomposite material of claim 10 and water, wherein the biocomposite material and water are present in a biocomposite material:water ratio of 0.9:1 to 1:1.

13. A method of preparing a masonry unit comprising steps of:
providing a biocomposite material comprising hydraulic lime binder and hemp hurd in a hydraulic lime binder:hemp hurd weight ratio of 1.4:1 to 1.6:1, wherein the hydraulic lime binder comprises less than 1% by weight of each of potassium oxide (K₂O), sodium oxide (Na₂O), and sulfur trioxide (SO₃), based on total weight of the hydraulic lime binder;
adding water to the biocomposite material with mixing to form a settable formulation, wherein water is added in an amount to achieve a biocomposite material:water ratio of 0.9:1 to 1:1;
providing the settable formulation into molds for a suitable time to allow initial set of the formulation;
removing the molds to expose masonry units; and
allowing the masonry units to cure.

14. The method of claim 13 further comprising removing fiber from hemp hurd prior to the step of providing a biocomposite material comprising hydraulic lime binder and hemp hurd in a weight ratio of 1.4:1 to 1.6:1.

15. The method of claim 13 wherein the step of allowing the masonry units to cure is performed at temperatures in a range of 65° F. to 80° F. and relative humidity in a range of 65% to 75%.

16. The method of claim 13 wherein the step of allowing the masonry units to cure comprises allowing the masonry units to cure for 28 days or less.

17. The method of claim 13 wherein the step of providing the settable formulation into molds further comprises compressing the settable formulation within the molds.

18. The method of claim 17 further comprising vibrating the settable formulation within the molds.

19. The method of claim 13 further comprising incorporating additives in the step of providing a biocomposite material comprising hydraulic lime binder and hemp hurd, or in the step of adding water to the biocomposite material, or in both steps.

20. The method of claim 19 wherein the additives comprise one or more of biochar, nanocellulose, and graphene.
